(19) United States
(12) Patent Application Publication
(10) Pub. No.: US 2026/0349248 A1
(43) Pub. Date: Nov. 5, 2026

(54) SLIM OPTICAL SYSTEM

(71) Applicant: SEKONIX CO., LTD., Dongducheon-si (KR)

(72) Inventors: Ki Youn NOH, Namyangju-si (KR); Sung Nyun KIM, Incheon (KR); In Jeong HWANG, Suwon-si (KR)

(21) Appl. No.: 19/466,075

(22) Filed: Jan. 30, 2026

(30) Foreign Application Priority Data
Feb. 3, 2025 (KR) 10-2025-0012998

(51) Int. Cl. G02B 27/00; G02B 13/18; G02B 27/28

(52) U.S. Cl. CPC G02B 27/0081; G02B 13/18; G02B 27/283; G02B 27/286

(57) ABSTRACT

Disclosed is a slim optical system including a first lens, a second lens, and a third lens sequentially arranged from an object side, wherein the first lens is a plano-convex lens having a positive refractive power, the third lens is a convex aspherical lens having a negative refractive power, the exit pupil diameter (EPD) is 8 mm or less, and the eye relief is 12 mm or less.

### CROSS REFERENCE TO RELATED APPLICATION

The present application claims priority to Korean Patent Application No. 10-2025-0012998, filed Feb. 3, 2025, the entire contents of which is incorporated herein for all purposes by this reference.

### BACKGROUND OF THE INVENTION

### 1. Field of the Invention

The present invention relates to an optical system including a 3P lens constituted by three lenses, and more particularly to a slim optical system capable of maintaining a wide field of view while minimizing the distance (eye relief) between a user's eye and a display.

A Korean national and development project supported by the Korean government associated with the present invention is described below:
Project Unique Number 2410002411
Project Ser. No. 00/453,508
Government Department MOTIE (Ministry of Trade, Industry and Energy)
Specialized Institution for Project Management KEIT (Korea Planning & Evaluation of Industrial Technology)
Title of Research Program Materials and Components Technology Development (R&D)
Title of Project Development of a qHD-class ultra-compact projection optical engine for AR and a 4K-class pancake-type lightweight optical module for MR
Performing Institute SEKONIX CO., LTD.
Research Period Jul. 1, 2024 ~ Dec. 31, 2027

### 2. Description of the Related Art

Recently, extended reality (XR) devices, such as virtual reality (VR) devices and augmented reality (AR) devices, have been gradually advancing, increasing the importance of head-mounted display (HMD) apparatuses.

HMD apparatuses require high resolution and a wide field of view (FOV) to provide users with an immersive virtual reality experience. Simultaneously, HMD apparatuses require a lightweight and compact structure to ensure comfort during prolonged wear.

Various approaches have been attempted in conventional optical system designs to meet these requirements. Pancake optics, in particular, play a crucial role in reducing the overall length (OAL) of VR-HMD systems and improving image quality.

The pancake optics use a complex optical path constituted by a polarizing beam splitter (PBS), a quarter-wave plate (QWP), a half mirror, etc. to reduce the thickness of the VR-HMD while enhancing visual performance. This design is a crucial technology that improves the usability of the VR-HMD and helps the user achieve a more vivid and immersive visual experience.

In conventional VR-HMD optical systems, however, stray light may degrade the quality of images users see. Stray light refers to light that is unnecessarily reflected or scattered in the optical system, causing image distortion or reducing contrast ratio, which lowers screen clarity.

This phenomenon is particularly problematic in VR-HMD environments in which high-resolution image implementation is critical. Conventional designs control the optical path in various ways to reduce stray light, but stray light remains without being completely eliminated.

Furthermore, the eye relief is defined as the minimum distance that must be maintained between a user's eye and a lens when a user wears the HMD. Failure to secure adequate eye relief may cause user discomfort during wear or result in image distortion.

However, increasing eye relief reduces the field of view (FOV). The FOV refers to the width of the visual field that the user can see on the screen, and a wide FOV is essential for an immersive VR experience.

In conventional VR-HMD designs, balancing the two factors is challenging, creating a trade-off between the eye relief and the FOV.

In addition, advanced optical designs such as the pancake optics increase system complexity. This heightens manufacturing process difficulties, raises costs, and requires precise alignment between optical components, leading to higher product prices and increased defect potential.

### SUMMARY OF THE INVENTION

In order to solve the above problems, it is necessary to design a new optical system, and it is an object according to the present invention to provide a slim optical system including a first lens, a second lens, and a third lens sequentially arranged from an object side and capable of maintaining a wide field of view while minimizing the distance (eye relief) between a user's eye and a display.

In accordance with the present invention, the above and other objects can be accomplished by the provision of a slim optical system including a first lens, a second lens, and a third lens sequentially arranged from an object side, wherein the first lens is a plano-convex lens having a positive refractive power, the third lens is a convex aspherical lens having a negative refractive power, the exit pupil diameter (EPD) is 8 mm or less, and the eye relief is 12 mm or less.

In addition, the slim optical system may include a display, an aperture, a quarter-wave plate (QWP), a polarizing beam splitter (PBS), and a half mirror, wherein the first lens may be located between the aperture and the quarter-wave plate (QWP), and the second lens and the third lens may be located between the first lens and an image plane.

Furthermore, in the slim optical system, the polarizing beam splitter (PBS) may be implemented on an image-side surface of the first lens, the quarter-wave plate (QWP) may be implemented on an object-side surface of the second lens, and the half mirror may be implemented on an image-side surface of the third lens.

In addition, an optical path of the slim optical system may be configured such that light generated from the display passes through the half mirror of the third lens, is converted from circular polarization (LCP) to linear polarization through the quarter-wave plate (QWP) of the second lens, is reflected by the polarizing beam splitter (PBS) of the first lens, is converted from the linear polarization to circular polarization (RCP) through the quarter-wave plate (QWP) of the second lens again, is reflected by the half mirror of the third lens, is converted from the circular polarization to linear polarization through the quarter-wave plate (QWP) of the second lens, and is transmitted to a user's pupil through the aperture.

In addition, the thickness (CT1) of the first lens, the thickness (CT2) of the second lens, the thickness (CT3) of the third lens, and the axial distance (T13) between the first lens and the third lens may satisfy 0<(CT1+CT2+CT3)/T13<1.5.

In addition, the Abbe number (V1) of the first lens, the Abbe number (V2) of the second lens, the Abbe number (V3) of the third lens may satisfy V1+V2+V3>100.

In addition, the curvature (Rdy S5) of an object-side surface of the second lens and the curvature (Rdy S6) of the image-side surface of the second lens may satisfy (Rdy S5)/(Rdy S6)<0.

In addition, the refractive power (P1) of the first lens, the refractive power (P2) of the second lens, and the refractive power (P3) of the third lens may satisfy −0.1<P1+P2+P3<0.1.

In addition, the exit pupil diameter (EPD) and the size (ImgH) of the image plane may satisfy EPD/ImgH<0.4.

In addition, the distortion (Dist) of the slim optical system may satisfy −100%<Dist<0.

### BRIEF DESCRIPTION OF THE DRAWINGS

FIG. 1 is a schematic view showing principal components of a slim optical system according to an embodiment of the present invention; and

FIG. 2 is a view showing aberration according to an embodiment of the present invention.

### DETAILED DESCRIPTION OF EXEMPLARY EMBODIMENTS

The present invention relates to an optical system including three lenses, e.g., a first lens, a second lens, and a third lens sequentially arranged from an object side. The system is designed with an exit pupil diameter (EPD) of 8 mm or less and an eye relief of 12 mm or less such that a wide field of view is maintained while the distance (eye relief) between a user's eye and a display is minimized.

Hereinafter, embodiments of the present invention will be described in detail with reference to the accompanying drawings.

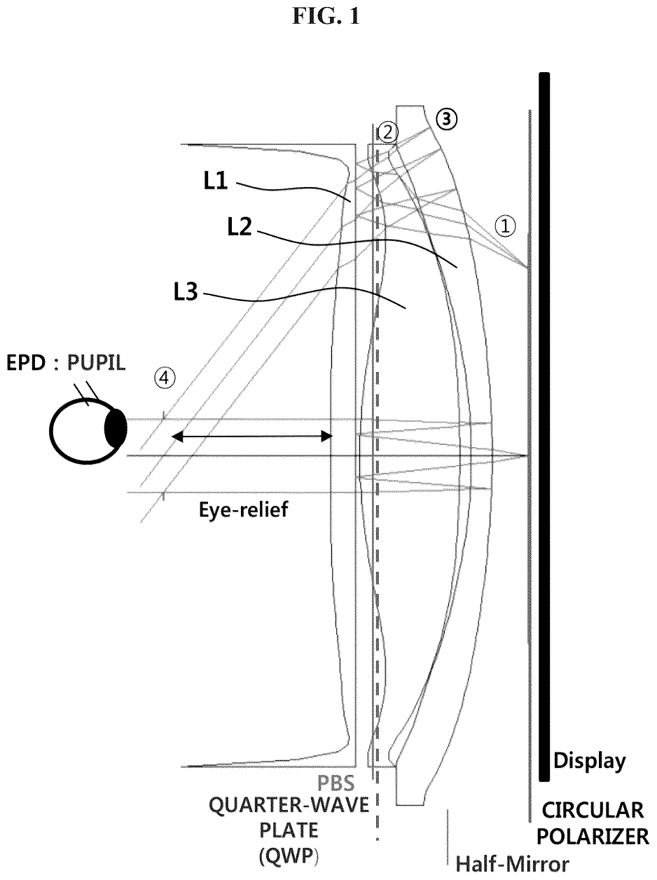

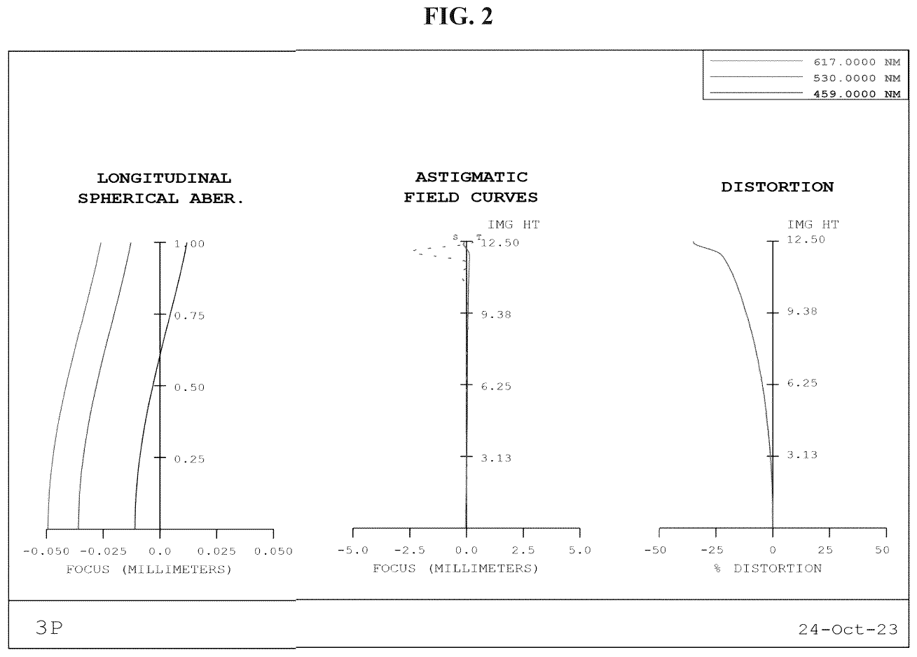

FIG. 1 is a schematic view showing principal components of a slim optical system according to an embodiment of the present invention, and FIG. 2 is a view showing aberration according to an embodiment of the present invention.

As shown, the slim optical system according to the embodiment of the present invention is a slim optical system including a first lens L1, a second lens L2, and a third lens L3 sequentially arranged from an object side, wherein the first lens L1 is a plano-convex lens having a positive refractive power, the third lens L3 is a convex aspherical lens having a negative refractive power, the exit pupil diameter (EPD) is 8 mm or less, and the eye relief is 12 mm or less.

The slim optical system is provided by appropriately designing the refractive powers and shape of the lenses such that the exit pupil diameter (EPD) is 8 mm or less and the eye relief is 12 mm or less, whereby a wide field of view is provided while the distance (eye relief) between a user's eye and a display is minimized.

The first lens L1 is a plano-convex lens having a positive refractive power, and serves to minimize distortion while collecting light due to the positive refractive power.

The third lens L3 is formed as a convex aspherical lens having a negative refractive power, whereby it is possible to provide a high-resolution image while reducing distortion of the optical system.

The optical system according to the present invention is designed to achieve a wide field of view, a slim design, and minimal distortion using only three lenses.

In addition, the slim optical system according to the embodiment of the present invention includes a display, an aperture, a quarter-wave plate (QWP), a polarizing beam splitter (PBS), and a half mirror. The first lens L1 is located between the aperture and the quarter-wave plate (QWP), and the second lens L2 and the third lens L3 are located between the first lens L1 and an image plane.

According to the embodiment of the present invention, in the slim optical system, it is preferable for the polarizing beam splitter (PBS) to be implemented on an image-side surface of the first lens L1, for the quarter-wave plate (QWP) to be implemented on an object-side surface of the second lens L2, and for the half mirror to be implemented on an image-side surface of the third lens L3.

According to the embodiment of the present invention, the display (image plane) and the aperture (which serves as an eye in front of the first lens L1) are located in front and at the rear of the slim optical system, respectively, to constitute the overall optical path.

The first lens L1 is located between the aperture and the display, and the image-side surface of the first lens L1, which is the polarizing beam splitter (PBS), splits the linear polarization of light, whereby the reflected polarization is affected depending on the angle of incidence and wavelength.

The object-side surface of the first lens L1 is formed as a plano-convex lens, which collects light and transmits the light to the other components of the system. The quarter-wave plate (QWP) is implemented on the object-side surface of the second lens L2, and the half mirror is implemented on the image-side surface of the third lens L3, whereby the polarization state of light is controlled and distortion is minimized.

An optical path of the slim optical system according to the embodiment of the present invention is configured such that light generated from the display passes through the half mirror of the third lens L3, is converted from circular polarization (LCP) to linear polarization through the quarter-wave plate (QWP) of the second lens L2, is reflected by the polarizing beam splitter (PBS) of the first lens L1, is converted from the linear polarization to circular polarization (RCP) through the quarter-wave plate (QWP) of the second lens L2 again, is reflected by the half mirror of the third lens L3, is converted from the circular polarization to linear polarization through the quarter-wave plate (QWP) of the second lens L2, and is transmitted to a user's pupil through the aperture.

The optical path according to the embodiment of the present invention is a path along which light emitted from the display reaches the human pupil. The lens closer to the display is referred to as the third lens L3, and the lens relatively closer to the eye is referred to as the first lens L1.

First, the circular polarization (LCP) of a beam emitted from the display passes through the half mirror of the third lens L3. The half mirror is designed with a reflectivity of 40 to 50%, reflecting half the light and transmitting the other half. The transmitted circular polarization (LCP) passes through the quarter-wave plate of the second lens L2, wherein the quarter-wave plate converts circular polarization to linear polarization (or linear polarization to circular polarization), thereby changing the direction of the beam (path \textcircled{1} in FIG. 1).

The linear S-polarization that has passed through the quarter-wave plate is reflected by the polarizing beam splitter (PBS) of the first lens L1, passes through the quarter-wave plate of the second lens L2, and reaches the half mirror of the third lens L3 as circular polarization (LCP) (path \textcircled{2} in FIG. 1).

The circular polarization reflected by the half mirror of the third lens L3 is converted to RCP, passes through the quarter-wave plate of the second lens L2, is converted to linear P-polarization, and reaches the EPD through the aperture (Path (3) in FIG. 1).

The polarization conversion and reflection along the optical path minimizes the generation of stray light, ultimately delivering a high-resolution image to the user.

In addition, according to the embodiment of the present invention, the thickness CT1 of the first lens L1, the thickness CT2 of the second lens L2, the thickness CT3 of the third lens L3, and the axial distance T13 between the first lens L1 and the third lens L3 satisfy 0<(CT1+CT2+CT3)/T13<1.5.

This minimizes the overall thickness of the optical system, enabling a slim design for HMD apparatuses. This allows a wearer to wear the HMD apparatus more comfortably and reduces fatigue during prolonged use.

In addition, according to the embodiment of the present invention, the Abbe number V1 of the first lens L1, the Abbe number V2 of the second lens L2, and the Abbe number V3 of the third lens L3 satisfy V1+V2+V3>100.

This design, in which the sum of the Abbe numbers of the first lens L1, the second lens L2, and the third lens L3 exceeds 100, minimizes chromatic aberration in the lenses and provides a clear image. Chromatic aberration is one of the key factors degrading image quality in high-resolution display apparatuses, and the above condition may effectively suppress chromatic aberration.

In addition, according to the embodiment of the present invention, the curvature Rdy S5 of the object-side surface of the second lens L2 and the curvature Rdy S6 of the image-side surface of the second lens L2 satisfy (Rdy S5)/(Rdy S6)<0.

This minimizes optical distortion occurring in the lens by setting the curvature ratio of the second lens L2. That is, the object-side curvature must be less than the image-side curvature. This reduces distortion that may occur during the light-gathering process of the lens, ultimately providing the user with a clear, distortion-free image.

In addition, according to the embodiment of the present invention, the refractive power P1 of the first lens L1, the refractive power P2 of the second lens L2, and the refractive power P3 of the third lens L3 satisfy −0.1<P1+P2+P3<0.1.

This design ensures that the sum of the refractive powers of the three lenses falls within a specific range, minimizing optical distortion and maintaining a constant focal length throughout the entire optical system, thereby optimizing the performance of the optical system.

In addition, according to the embodiment of the present invention, in the slim optical system, the exit pupil diameter (EPD) and the size ImgH of an image plane satisfy EPD/ImgH<0.4.

This aims to achieve optimal system performance by adjusting the ratio between the optical path in the optical system and the size of an image. The EPD must be designed to be much less than ImgH, enabling the system to provide a wider field of view.

In addition, according to the embodiment of the present invention, the distortion Dist of the slim optical system satisfies −100%<Dist<0. That is, distortion is always negative, causing the distortion generated in the optical system to manifest as barrel distortion. This suppresses the distortion within a certain range, ensuring that an image seen by the user appears natural and consistent. Although the distortion is barrel distortion, the degree of the distortion is adjusted to minimize visual discomfort for the user.

As such, the present invention provides a slim optical system including three aspherical lenses configured to have a wide field of view, a slim design, and minimized distortion and chromatic aberration.

Hereinafter, an embodiment of the present invention will be described with reference to the accompanying drawings.

FIG. 1 shows an embodiment of the slim optical system according to the present invention.

As shown, the slim optical system according to the embodiment of the present invention includes a first lens L1, a second lens L2, and a third lens L3 sequentially arranged from an object side, wherein the first lens L1 is a plano-convex lens having a positive refractive power and a convex object-side surface, the third lens L3 is a convex aspherical lens having a negative refractive power, the exit pupil diameter (EPD) is 8 mm or less, and the eye relief is 12 mm or less.

The slim optical system includes a display, an aperture, a quarter-wave plate (QWP), a polarizing beam splitter (PBS), and a half mirror. The first lens L1 is located between the aperture and the quarter-wave plate (QWP), and the second lens L2 and the third lens L3 are located between the first lens L1 and an image plane. The polarizing beam splitter (PBS) is implemented on an image-side surface of the first lens L1, the quarter-wave plate (QWP) is implemented on an object-side surface of the second lens L2, and the half mirror is implemented on an image-side surface of the third lens L3.

Table 1 below shows numerical data of the lenses constituting the optical system according to the embodiment of the present invention.

TABLE 1

| | | Surface | | | | Y Semi- |
|---|---|---|---|---|---|---|
| | | Type | Y Radius | Thickness | Glass Code | Aperture |
| | Object | Sphere | infinity | infinity | | |
| | 1 | Sphere | infinity | 0.0000 | | 2.4532 |
| | 2 | Sphere | infinity | 12.0000 | | 2.5000 |
| L1 | 3 | Qcon | 305.2937 | 1.8129 | 509200.563 | 18.2004 |
| | | Asphere | | | | |
| | 4 | Sphere | infinity | 0.3048 | | 18.4482 |
| L2 | 5 | Qcon | 33.9304 | 7.2000 | 509200.5630 | 19.2238 |
| | | Asphere | | | | |
| | Stop | Qcon | −83.0922 | 0.8193 | | 19.9626 |
| | | Asphere | | | | |
| L3 | 7 | Qcon | −34.6341 | 1.5001 | 640000.2340 | 20.4871 |
| | | Asphere | | | | |
| | 8 | Qcon | −58.5364 | −1.5001 | 640000.2340 | 21.9724 |
| | | Asphere | | | | |
| | 9 | Qcon | −34.6341 | −0.8193 | | 20.8061 |
| | | Asphere | | | | |
| | 10 | Qcon | −83.0922 | −7.2000 | 509200.5630 | 20.3066 |
| | | Asphere | | | | |
| | 11 | Qcon | 33.9304 | −0.3048 | | 19.8728 |
| | | Asphere | | | | |
| | 12 | Sphere | infinity | 0.3048 | | 19.4838 |
| | 13 | Qcon | 33.9304 | 7.2000 | 509200.5630 | 18.9786 |
| | | Asphere | | | | |
| | 14 | Qcon | −83.0922 | 0.8193 | | 18.7843 |
| | | Asphere | | | | |
| | 15 | Qcon | −34.6341 | 1.5001 | 640000.2340 | 17.2073 |
| | | Asphere | | | | |
| | 16 | Qcon | −58.5364 | 0.2000 | | 16.3133 |
| | | Asphere | | | | |
| | 17 | Sphere | infinity | 0.0000 | | 14.2612 |
| | 18 | Sphere | infinity | 0.0000 | | 14.2612 |
| | 19 | Sphere | infinity | 2.3366 | | 14.2612 |
| | Image | Sphere | infinity | 0.0359 | | 12.8073 |

The Qcon polynomial of each of the first lens L1, the second lens L2, and the third lens L3 based on Qcon asphere thereof is represented by Mathematical Expression 1 below.

$$z = \frac{{cr}^{2}}{1 + \sqrt{1 - ( 1 + k ) {c}^{2} {r}^{2}}} + {u}^{4} {\sum }_{m = 0}^{13} {a}_{m} {Q}_{m}^{con} ( {u}^{2} ) \qquad [ Mathematical Expression 1 ]$$

Here, z indicates sag of a surface parallel to a z axis in the optical system, c indicates the vertex curvature of the lens at the vertex thereof, k indicates a conic constant, r indicates radial distance of the lens from the axis thereof, rₙ indicates a normalization radius, u indicates r/rₙ, aₘ indicates an m-th Qcon coefficient, and Qₘ^{con} indicates an m-th Qcon polynomial.

Qcon coefficients are obtained from Mathematical Expression 1 above as shown in Table 2 below.

TABLE 2

| Surface | 3 | 5 | 7 |
|---|---|---|---|
| Y Radius | 3.05294.E+02 | 3.39304.E+01 | −3.46341.E+01 |
| Nomalization | 1.74454.E+01 | 1.88460.E+01 | 2.03233.E+01 |
| Radius | | | |
| Conic Constant | −7.21602.E+02 | 3.84402.E−01 | 1.29171.E−01 |
| 4th Qcon | 8.31561.E−01 | −4.74637.E+00 | 1.42428.E+00 |
| Coefficient | | | |
| 6th Qcon | −2.10138.E−01 | −3.66136.E−01 | 8.29343.E−02 |
| Coefficient | | | |
| 8th Qcon | 3.07656.E−02 | 6.62300.E−02 | −6.25909.E−02 |
| Coefficient | | | |
| 10th Qcon | 5.98169.E−02 | 3.34428.E−02 | −8.32855.E−02 |
| Coefficient | | | |
| 12th Qcon | −8.87486.E−03 | −3.72239.E−03 | −5.72995.E−04 |
| Coefficient | | | |
| 14th Qcon | −1.08602.E−02 | −2.41147.E−03 | 3.03020.E−02 |
| Coefficient | | | |
| 16th Qcon | −1.43475.E−03 | 2.73251.E−04 | 1.82073.E−02 |
| Coefficient | | | |
| 18th Qcon | 5.83202.E−03 | 4.08930.E−05 | 0.00000.E+00 |
| Coefficient | | | |
| 20th Qcon | −1.79725.E−03 | 7.23903.E−04 | 0.00000.E+00 |
| Coefficient | | | |
| 22nd Qcon | 0.00000.E+00 | 2.53250.E−06 | 0.00000.E+00 |
| Coefficient | | | |
| 24th Qcon | 0.00000.E+00 | 2.54857.E−07 | 0.00000.E+00 |
| Coefficient | | | |
| 26th Qcon | 0.00000.E+00 | 4.60296.E−06 | 0.00000.E+00 |
| Coefficient | | | |
| 28th Qcon | 0.00000.E+00 | 3.44430.E−06 | 0.00000.E+00 |
| Coefficient | | | |
| 30th Qcon | 0.00000.E+00 | 3.19925.E−06 | 0.00000.E+00 |
| Coefficient | | | |

Tables 3 and 4 below show the design values of the optical system according to the embodiment of the present invention.

TABLE 3

| | | | | | |
|---|---|---|---|---|---|
| F/f1 | 0.0220262243 | L1_f1 | 595.8942 | V1 | 56.30 |
| F/f2 | 0.273294154 | L2_f2 | 48.0263 | V2 | 56.30 |
| F/f3 | −0.306884739 | L3_f3 | −42.7695 | V3 | 23.40 |
| F/f1 + F/f2 | 0.295320378 | f1/f2 | 12.4077 | | |
| F/f1 + F/F3 | −0.284858514 | | | | |
| | | ct s2/et s2 | 3.0221 | | |
| P1 | 0.00167815016 | ct s5/et s5 | 5.6945 | | |
| P2 | 0.0208219358 | ct s7/et s7 | 0.6295 | | |
| P3 | −0.0233811599 | | | | |
| P1 + P2 + P3 | −0.001 | L1 ct/L2 ct | 0.2518 | | |

Here, F indicates the effective focal length of the entire optical system, f1(L1_f1), f2(L2_f2), and f3(L3_f3) indicate the focal lengths of the first lens L1, the second lens L2, and the third lens L3, respectively, and P1, P2, and P3 indicate the refractive powers of the first lens L1, the second lens L2, and the third lens L3, respectively. In addition, ct indicates the center thickness of each lens surface (image-side surface and object-side surface), et indicates the thickness of the outermost edge of the effective diameter of each lens surface (image-side surface and object-side surface), L1 ct indicates the center thickness of the first lens L1, and L2 ct indicates the center thickness of the second lens L2.

Furthermore, airgap indicates the total air gap of the entire optical system, and V1, V2, and V3 indicate the Abbe numbers of the first lens L1, the second lens L2, and the third lens L3, respectively.

TABLE 4

| | |
|---|---|
| Effective Focal length | 13.1253 |
| Back Focal length(bfl) | 2.337 |
| Total length(TTL) | 26.2097 |
| FOV | 100 |
| cra | 33.8 |
| TTL/Image H | 1.36 |
| fno | 4.84 |
| dist | −35% |
| IH | 19.21 |
| All airgap | 1.124 |
| Air gap/TTL | 0.0428906332 |
| HFOV | 50.00 |
| HFOV/(EFL + TTL) | 1.27 |

Effective Focal Length (EFL) is the effective focal length (F) of the entire optical system, Back Focal Length (bfl) is the rear focal length (distance from the last surface of the optical system to the focal point), Total length (TTL) is the overall length of the optical system (distance from the center of the object-side surface to the image plane), FOV (Field of View) is the angle of view, HFOV (Half Field of View) is half of FOV, and Image H (IH) is the height of the image plane. In addition, cra (Chief Ray Angle) max indicates the maximum size of the chief ray angle, and dist indicates distortion.

In the embodiment of the present invention, the distortion dist of the optical system satisfies −100%<dist<0, thereby always providing a barrel-shaped distorted image.

In the embodiment of the present invention, fno (f-number) of the optical system satisfies fno (f-number)=4.84, enabling clear image quality even with low light intensity. This allows for a larger aperture diameter, achieving bright image quality even in dark environments, whereby it is possible to provide a compact optical system with high resolution and high image quality. This configuration provides an optical system with a large field of view and a sufficiently low f-number, thereby achieving bright image quality.

FIG. 2 is a view showing aberration according to an embodiment of the present invention.

First data of FIG. 2 show spherical aberration, wherein the horizontal axis indicates focus (mm), the vertical axis indicates image height (mm), and respective graphs indicate the wavelengths of incident rays. It is known that the more the graphs approach the central vertical axis line and approach each other, as shown, the better the efficiency of correcting spherical aberration. The spherical aberration according to the first embodiment of the present invention is 0.025 mm (focus) or less, which is determined to be good.

Second data of FIG. 2 show astigmatism aberration, wherein the horizontal axis indicates focus (mm), the vertical axis indicates the angle of incidence (deg), graph S indicates sagittal, which is a ray incident in a direction parallel to the lens, and graph T indicates tangential, which is a ray incident in a direction perpendicular to the lens. It is known that the more graphs S and T approach each other and approach the central vertical axis, the better the efficiency of correcting astigmatism aberration.

Third data of FIG. 2 show distortion aberration, wherein the horizontal axis indicates distortion degree (dist, %), and the vertical axis indicates the angle of incidence (deg). In the embodiment of the present invention, −100%<dist<0 is satisfied, whereby a barrel-shaped distorted image is always provided.

As is apparent from the above description, the present invention relates to an optical system including a 3P lens constituted by three lenses, e.g., a first lens, a second lens, and a third lens sequentially arranged from an object side. The system is designed with an exit pupil diameter (EPD) of 8 mm or less and an eye relief of 12 mm or less such that a wide field of view is maintained while the distance (eye relief) between a user's eye and a display is minimized.

According to an embodiment of the present invention, stray light is effectively suppressed, significantly enhancing the contrast ratio and clarity of an image seen by a user, whereby it is possible to realize a high-resolution image and to minimize visual distortion.

In addition, according to the embodiment of the present invention, the optical system is designed to provide a wide field of view while maintaining an appropriate eye relief, which allows the user to achieve an immersive virtual reality experience while minimizing discomfort during prolonged wear.

Furthermore, according to the embodiment of the present invention, the optical system including the three lenses is adopted, realizing a thinner and lighter design than existing systems, whereby it is possible to improve wearability and portability of a VR-HMD.

Moreover, according to the embodiment of the present invention, the Abbe numbers and refractive powers of the lenses are appropriately adjusted to minimize chromatic aberration and distortion, which provides the user with a clear, undistorted image and enables a more natural visual experience. Therefore, the slim optical system according to the embodiment of the present invention enables the HMD apparatus to have a lightweight and slim design, minimizing user fatigue even during prolonged wear and increasing convenience.

What is claimed is:

1. A slim optical system comprising a first lens, a second lens, and a third lens sequentially arranged from an object side, wherein
the first lens is a plano-convex lens having a positive refractive power,
the third lens is a convex aspherical lens having a negative refractive power,
an exit pupil diameter (EPD) is 8 mm or less, and
an eye relief is 12 mm or less.

2. The slim optical system according to claim 1, comprising:
a display;
an aperture;
a quarter-wave plate (QWP);
a polarizing beam splitter (PBS); and
a half mirror, wherein
the first lens is located between the aperture and the quarter-wave plate (QWP), and
the second lens and the third lens are located between the first lens and an image plane.

3. The slim optical system according to claim 2, wherein
the polarizing beam splitter (PBS) is implemented on an image-side surface of the first lens,
the quarter-wave plate (QWP) is implemented on an object-side surface of the second lens, and
the half mirror is implemented on an image-side surface of the third lens.

4. The slim optical system according to claim 3, wherein an optical path of the slim optical system is configured such that light generated from the display passes through the half mirror of the third lens, is converted from circular polarization (LCP) to linear polarization through the quarter-wave plate (QWP) of the second lens, is reflected by the polarizing beam splitter (PBS) of the first lens, is converted from the linear polarization to circular polarization (RCP) through the quarter-wave plate (QWP) of the second lens again, is reflected by the half mirror of the third lens, is converted from the circular polarization to linear polarization through the quarter-wave plate (QWP) of the second lens, and is transmitted to a user's pupil through the aperture.

5. The slim optical system according to claim 1, wherein a thickness (CT1) of the first lens, a thickness (CT2) of the second lens, a thickness (CT3) of the third lens, and an axial distance (T13) between the first lens and the third lens satisfy 0<(CT1+CT2+CT3)/T13<1.5.

6. The slim optical system according to claim 1, wherein an Abbe number (V1) of the first lens, an Abbe number (V2) of the second lens, and an Abbe number (V3) of the third lens satisfy V1+V2+V3>100.

7. The slim optical system according to claim 1, wherein a curvature (Rdy S5) of an object-side surface of the second lens and a curvature (Rdy S6) of the image-side surface of the second lens satisfy (Rdy S5)/(Rdy S6)<0.

8. The slim optical system according to claim 1, wherein a refractive power (P1) of the first lens, a refractive power (P2) of the second lens, and a refractive power (P3) of the third lens satisfy −0.1<P1+P2+P3<0.1.

9. The slim optical system according to claim 1, wherein the exit pupil diameter (EPD) and a size (ImgH) of an image plane satisfy EPD/ImgH<0.4.

10. The slim optical system according to claim 1, wherein a distortion (Dist) of the slim optical system satisfies −100%<Dist<0.
